(19) United States
(12) Patent Application Publication
(10) Pub. No.: US 2025/0256749 A1
(43) Pub. Date: Aug. 14, 2025

(54) WHEEL CHOCK CART

(71) Applicant: Checkers Industrial Products, LLC, Broomfield, CO (US)

(72) Inventors: Jacob Meister, Broomfield, CO (US); Greg Widgery, Broomfield, CO (US); Duncan Shallcross-Cecchini, Burgettstown, PA (US)

(73) Assignee: Checkers Industrial Products, LLC, Broomfield, CO (US)

(21) Appl. No.: 18/436,281

(22) Filed: Feb. 8, 2024

(51) Int. Cl. B62B 1/12; B62B 5/00; B64F 1/16

(52) U.S. Cl. CPC B62B 1/12; B62B 5/00; B62B 2202/48; B64F 1/16

(57) ABSTRACT

An apparatus can include a wheeled chock cart for moving wheel chocks in an outdoor environment. The wheeled chock cart can include: a bottom shelf sized and shaped to receive a power supply; a mounting sleeve attached to the bottom shelf; a post removably disposed within and fastened to the mounting sleeve, the post defining a plurality of apertures; a whip mount attached to the post; a whip attachable to the whip mount; a handle attached to a top portion of the post; and a pair of wheel chock baskets removably mounted to the post at an aperture of the plurality of apertures.

### FIELD

The described examples relate generally to wheel chock carts.

### BACKGROUND

Wheel chocks can include wedges of material to place closely against the wheels of a vehicle to prevent unintended movement or rotation of the wheels. In some examples, wheel chocks are used in combination with brakes (e.g., parking brakes) to prevent accidental movement of the vehicle when the vehicle is intended to remain stationary. Wheel chocks can be used in many different industries. In some examples, wheel chocks are used in the aviation industry to help maintain an aircraft in position (e.g., when parked in a hangar, during maintenance procedures, or when loading or boarding an aircraft).

Moving wheel chocks has a variety of drawbacks. For example, moving wheel chocks can be a laborious task that typically involves a user bending over to grab the wheel chock, carrying the wheel chock to a desired location, and again bending over to set the wheel chock on a ground surface. This process is repeated over and over throughout a work day for some wheel chock users, such as ground personnel at airport tarmacs and terminals who marshal aircraft. In some cases, to avoid laborious aspects, wheel chock users may choose to move wheel chocks in undesirable ways (e.g., kicking, tossing, sliding, etc.) that may accelerate the life cycle of a wheel chock and/or lend to inefficient field operations. When wheel chocks are not in use, a wheel chock can be improperly positioned in a way that results in the wheel chock being lost or in a way that encumbers vehicle traffic. Accordingly, there is a constant need for convenient, ergonomic wheel chock storage and transport, particularly for outdoor environments and around aircraft.

In addition, delineators, warning cones, barrels, cable stands, and channelizers are commonly used to direct and warn vehicle operators and pedestrians. At airports, these devices are often used to delineate paths across the tarmac and at terminals to keep aircraft in “safe zones” that keep aircraft from colliding with structures, vehicles, and personnel on the ground surface. These devices can also be laborious to move. Furthermore, these warning devices are often too short in height for pilots or drivers to see and accurately judge their vehicle's proximity to them. Contact between the vehicle and the warning devices may damage the vehicle and/or destroy the warning device. As a result, there is a need for an improved delineator that is conveniently transportable, easily seen in terms of height and visibility, and configured for safe contact or abutment with a vehicle.

The subject matter claimed herein is not limited to examples that solve any disadvantages or that operate only in environments such as those described above. Rather, this background is only provided to illustrate one example technology area where some examples described herein may be practiced.

### SUMMARY

An aspect of the present disclosure relates to a wheeled cart. The wheeled cart can include a wheel base that includes a pair of wheels, axle braces positioned adjacent to each wheel of the pair of wheels, and an axle coupling the pair of wheels and extending through the axle braces. The wheeled cart can additionally include a bottom shelf integrally attached to the wheel base via the axle braces, the bottom shelf sized and shaped to receive a power supply. The wheel cart can further include: a mounting sleeve integrally attached to the bottom shelf; a central support column removably disposed within and fastened to the mounting sleeve, the central support column having a plurality of attachment positions; a whip mount positioned at a top portion of the central support column; a handle attached to the central support column adjacent to the whip mount; and a pair of wheel chock baskets positioned forward of the central support column and above the bottom shelf, the pair of wheel chock baskets being removably mounted to the central support column at a first attachment position of the plurality of attachment positions. In some examples, the wheeled cart is self-standing in an upright position when at rest, and the wheeled cart is configured to be pushed or pulled when at an angled position relative to the upright position.

The wheeled cart can further include a wand basket removably mounted to the central support column at a second attachment position of the plurality of attachment positions. In some examples, the wheeled cart can include a charging dock positioned adjacent to or integrally formed within the wand basket. In at least one example, the wheeled cart can include a power cable routed through the central support column to provide power to one or more components, the power cable connectable to the power supply. In one example, the power cable extends to and is electrically connectable with the whip mount.

In particular implementations, the wheeled cart can include a solar array removably attached to the central support column at a second attachment position of the plurality of attachment positions, the solar array electrically connectable with at least one of the power supply or the whip mount. In certain examples, the wheeled cart includes a mounting bracket positionable longitudinally along the central support column, the mounting bracket being removably mounted to the central support column at a second attachment position of the plurality of attachment positions, wherein the mounting bracket is positioned between and integrally attached to the pair of wheel chock baskets. In one example, the mounting bracket is positioned perpendicular to the pair of wheel chock baskets. The wheeled cart can further include a whip attached to the whip mount. The whip can include at least one of a flag, light, or reflective surface.

Another aspect of the present disclosure relates to a cart for moving aviation wheel chocks in an outdoor environment. The cart can include: a bottom shelf sized and shaped to receive a power supply; a mounting sleeve attached to the bottom shelf; a post removably disposed within and fastened to the mounting sleeve, the post defining a plurality of apertures; a whip mount attached to the post; a whip attachable to the whip mount; a handle attached to a top portion of the post; and a pair of wheel chock baskets removably mounted to the post at an aperture of the plurality of apertures.

In some examples, the cart is configured to be visible in the outdoor environment during nighttime or inclement weather. In at least one example, the cart is configured to self-stand and remain in place when exposed to jet wash or windy conditions. In one or more examples, when the whip is attached to the whip mount, the whip is sized and oriented at a height to align aircraft wing tips at predetermined positions in the outdoor environment. In one example, the pair of wheel chock baskets is height adjustable from the aperture of the plurality of apertures to a different aperture of the plurality of apertures. In certain implementations, the whip includes a light assembly powered by the power supply. In some examples, the whip mount comprises a power connection to the power supply; and the whip mount is angularly oriented relative to the post such that, upon exposure to water, the water is shed away from the power connection.

Yet another aspect of the present disclosure relates to a wheel chock cart that can include: a bottom shelf sized and shaped to receive a power supply; a mounting sleeve attached to the bottom shelf; a post removably disposed within and fastened to the mounting sleeve, the post defining a plurality of apertures; a whip mount attached to the post; a whip attachable to the whip mount and comprising a light assembly; a power cable extending through the post and connectable with the light assembly; a handle attached to a top portion of the post; a pair of wheel chock baskets removably mounted to the post at a first aperture of the plurality of apertures; and a wand basket removably mounted to the post at a second aperture of the plurality of apertures. In some examples, the pair of wheel chock baskets is interchangeable with a different pair of wheel chock baskets. In at least one example, each wheel chock basket of the pair of wheel chock baskets is sized and shaped to receive a first wheel chock; and each wheel chock basket of the different pair of wheel chock baskets is sized and shaped to receive a second wheel chock different from the first wheel chock.

### BRIEF DESCRIPTION OF THE DRAWINGS

The disclosure will be readily understood by the following detailed description in conjunction with the accompanying drawings, wherein like reference numerals designate like structural elements, and in which:

FIGS. 1A-1B illustrate a wheel chock cart in accordance with one or more examples of the present disclosure;

FIGS. 2-4 respectively illustrate perspective, top, and side views of a wheel chock cart in accordance with one or more examples of the present disclosure;

FIG. 5 illustrates an assembled portion of a wheel chock cart in accordance with one or more examples of the present disclosure;

FIGS. 6A-6B respectively illustrate perspective and side views of a central support column in accordance with one or more examples of the present disclosure;

FIGS. 7A-7C illustrate a connection between a pair of wheel chock baskets and a central support column in accordance with one or more examples of the present disclosure;

FIG. 8 illustrates various components attached to a wheel chock cart in accordance with one or more examples of the present disclosure;

FIG. 9 illustrates a detailed view of a whip mount on a wheel chock cart in accordance with one or more examples of the present disclosure; and

FIG. 10 illustrates a solar array attachable to a wheel chock cart in accordance with one or more examples of the present disclosure.

### DETAILED DESCRIPTION

Reference will now be made in detail to representative examples illustrated in the accompanying drawings. It should be understood that the following descriptions are not intended to limit the examples to one preferred example. To the contrary, it is intended to cover alternatives, modifications, and equivalents as can be included within the spirit and scope of the described examples as defined by the appended claims.

The following disclosure relates to a wheel chock cart that can store and move wheel chocks. In particular implementations, the wheel chock cart of the present disclosure also includes one or more whips extending from the wheel chock cart (e.g., to signal operators or pilots of their vehicle's position).

In some examples the wheel chock cart can include one or more wheel chock baskets (e.g., a pair of wheel chock baskets) that can be adjustably mounted to the wheel chock cart. For example, a wheel chock basket can be mounted at various heights and/or in a variety of configurations relative to the wheel chock cart. The wheel chock basket in some examples is removably attached to a front portion of the wheel chock cart.

In these or other examples, the wheel chock cart can include a plurality of adjustment positions where the wheel chock basket(s) can be mounted. In some examples, the plurality of adjustment positions are interspaced along a support column or mounting post, including along front, side and/or rear faces of the support column.

A bottom shelf can be positioned at a bottom portion of the wheel chock cart (e.g., underneath the wheel chock basket(s). At least one battery or other power supply can be positioned on the bottom shelf to provide power to one or more components of the wheel chock cart. For example, the power supply can provide power to a light assembly or other illumination element associated with a whip attached to a top portion of the wheel chock cart. Likewise, the power supply can provide power to a charging dock (e.g., for charging martialing wands, computing devices (e.g., cell phones, tablets), hearing protection devices, etc.). Additionally or alternatively, in some examples the power supply can be charged via a solar array removably attachable to the wheel chock cart.

As just mentioned, the wheel chock cart can include a whip attachable to a whip mount. In these or other examples, a whip attached to the wheel chock cart can impart desired visibility and/or signaling attributes to the wheel chock cart, particularly for outdoor environments and/or around aircraft. For instance, via one or more whips attached to the wheel chock cart, the wheel chock cart can span a height that far exceeds a conventional delineator. The added height can, in some examples, reach an aircraft wing to provide visible and safe (e.g., pliant or flexible) contact between the whip(s) and the aircraft to signal the aircraft's relative positioning.

The wheel chock cart of the present disclosure can also provide enhanced visibility regardless of inclement weather, nighttime conditions, windy conditions, or jet wash (e.g., air turbulence from aircraft wake)—whereas typical carts or hand trucks would be near invisible or blown over/away in such conditions. Even with locked wheels, conventional carts would be easily blown over/away when exposed to jet wash, as an example. Conversely, the wheel chock cart of the present disclosure can include a robust, self-standing design capable of remaining in place and withstanding harsh outdoor environmental/workplace conditions. For example, the bottom shelf and wheel chock basket(s) can provide a counterbalancing effect against jet wash and wind forces, particularly when the bottom shelf and/or wheel chock basket(s) are filled with power supplies and wheel chocks. The wheel chock basket(s) can also be height adjustable (e.g., to lower a center of gravity for the wheel chock cart).

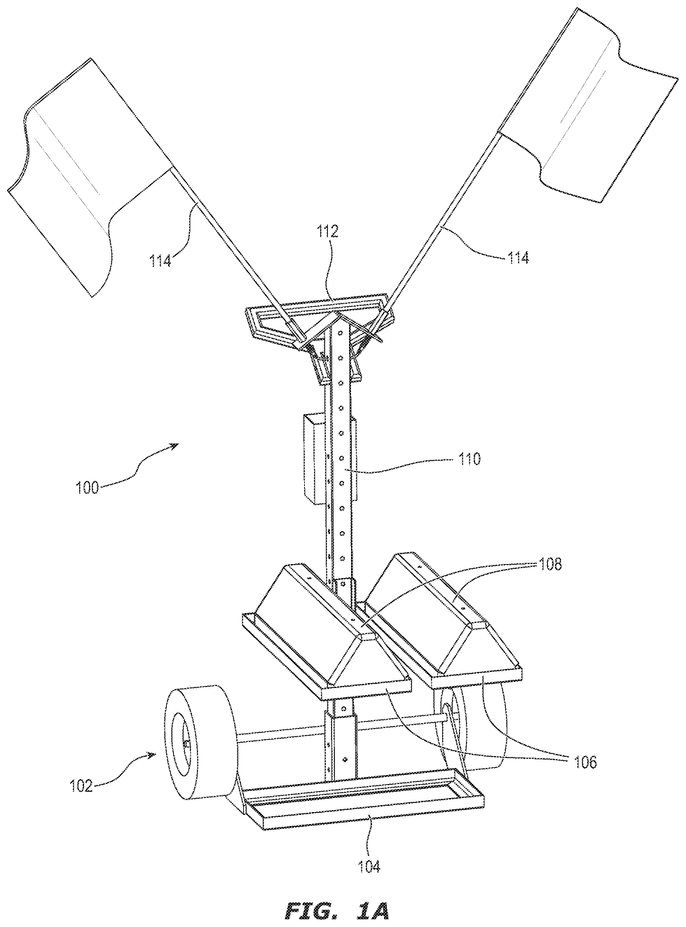

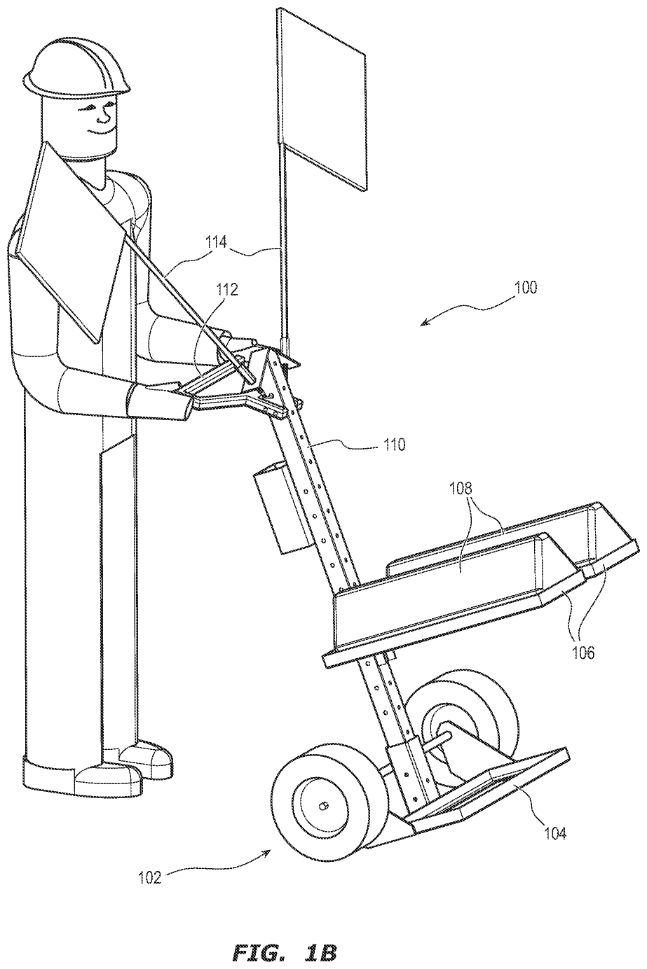

These and other examples are discussed below with reference to FIGS. 1-10. However, a person of ordinary skill in the art will readily appreciate that the detailed description given herein with respect to these figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIGS. 1A-1B illustrate a wheel chock cart 100 in accordance with one or more examples of the present disclosure. In particular, FIG. 1A illustrates the wheel chock cart 100 in an upright position when at rest (e.g., a self-standing position), and FIG. 1B illustrates the wheel chock cart 100 in an angled position for pushing or pulling the wheel chock cart 100.

As shown, the wheel chock cart 100 can include a wheel base 102. The wheel base 102 can include a pair of wheels and one or more components associated with the pair of wheels. In some examples, the wheel base 102 can include an axle. The axle can include a shaft that rotates with the pair of wheels. In other examples, the axle can include a fixed shaft (where the pair of wheels rotate relative to the fixed axle via a bearing engagement. Additionally or alternatively, the wheel base 102 can include a pair of axle braces (discussed more below in relation to FIG. 5).

The wheel chock cart 100 can further include a bottom shelf 104 attached to the wheel base 102. The bottom shelf 104 can be sized and shaped to receive (e.g., store, hold, support, or transport) one or more objects. In particular examples, the bottom shelf 104 is sized and shaped to receive at least one power supply (not shown). Examples of the bottom shelf 104 can include any shelf, platform, deck, carrier, basket, holder, stand, rack, receptacle, bin, box, container, trestle, scaffold, framework, etc. As shown, the bottom shelf 104 includes a polygon-shaped bracket or frame defining a central opening. In this case, the bracket or frame of the bottom shelf 104 is rectangular shaped, albeit other polygonal shapes can be utilized. The bracket or frame of the bottom shelf 104 can include a lip or sidewall (e.g., to better retain one or more objects on or within the bottom shelf 104). The central opening of the bottom shelf 104 can allow wind and water to pass through. In some implementations, however, the bottom shelf 104 forms a fully enclosed bottom surface.

In some examples, the bottom shelf 104 is removably attached to the wheel base 102. In other examples, the bottom shelf 104 is integrally (e.g., permanently) attached to the wheel base 102, such as via one or more welded joints. In particular examples, the bottom shelf 104 is integrally attached to the wheel base 102 via the axle braces (as will be discussed more below in relation to FIG. 5).

As mentioned, the bottom shelf 104 can be sized and shaped to receive a power supply (or multiple power supplies). As used herein, the term “power supply” refers to any power source that can supply power to one or more components of the wheel chock cart 100 (e.g., to charge a battery, power a light assembly associated with whips 114, and/or assist in moving or driving the wheel chock cart 100). For example, a power supply can include fuel cells, battery cells, generators, alternators, solar power converters, motion-based converters (e.g., that convert vibrations or oscillations into power), etc. In particular implementations, a power supply can convert alternating current to direct current (or vice-versa) for charging or recharging components of the wheel chock cart 100. Some particular examples of a power supply can include a switched mode power supply, an uninterruptible power supply, an alternating current power supply, a direct current power supply, a regulated power supply, a programmable power supply, a computer power supply, and a linear power supply. In at least one example, a power supply includes a rechargeable battery (e.g., a 12 volt, 600 amps rechargeable marine battery).

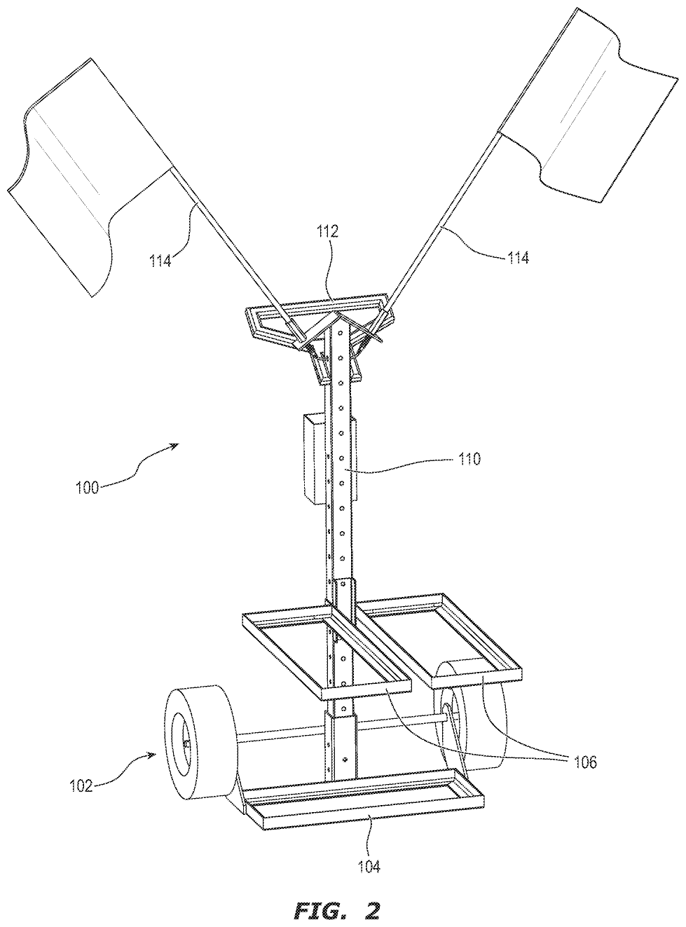

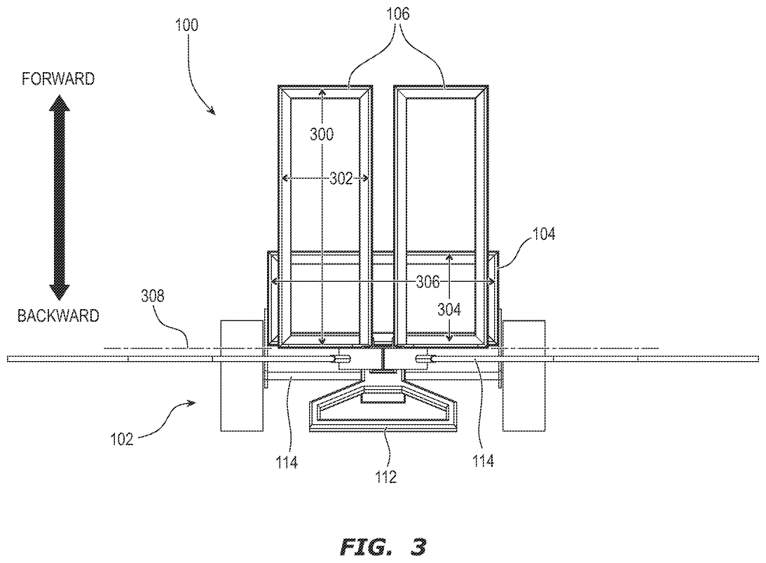

Further shown, the wheel chock cart 100 can include one or more wheel chock baskets 106 (e.g., a pair of wheel chock baskets). Like the bottom shelf 104, the wheel chock baskets 106 can be sized and shaped to receive (e.g., store, hold, support, or transport) one or more objects. In particular examples, the wheel chock baskets 106 are sized and shaped to receive wheel chocks 108, however. Examples of the wheel chock baskets 106 can include any shelf, platform, deck, carrier, basket, holder, stand, rack, receptacle, bin, box, container, trestle, scaffold, framework, etc. As shown (particularly in FIGS. 2-3), the wheel chock baskets 106 include a polygon-shaped bracket or frame defining a central opening. In this case, the bracket or frame of the wheel chock baskets 106 are rectangular shaped, albeit other polygonal shapes can be utilized. The bracket or frame of the wheel chock baskets 106 can include a lip or sidewall (e.g., to better retain one or more objects on or within the wheel chock baskets 106). The central opening of the wheel chock baskets 106 can allow wind and water to pass through. In some implementations, however, the wheel chock baskets 106 forms a fully enclosed bottom surface.

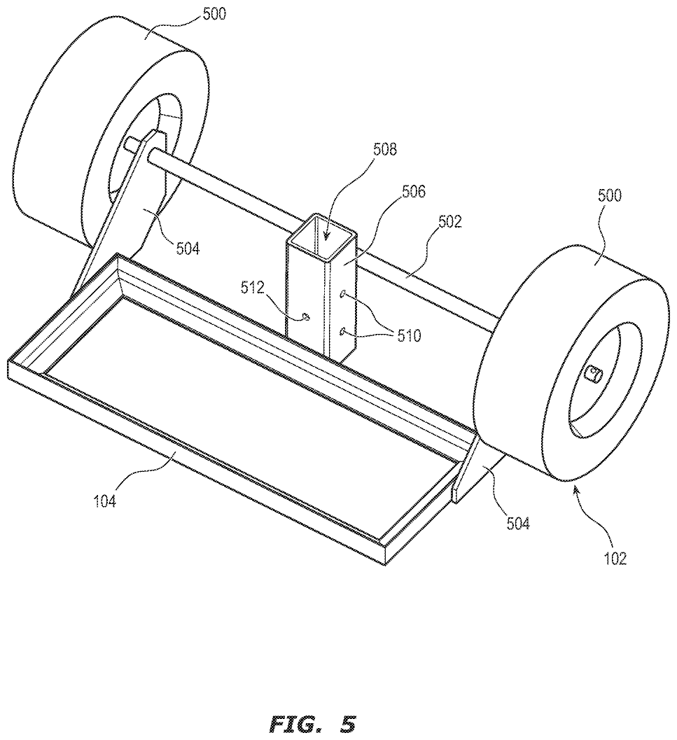

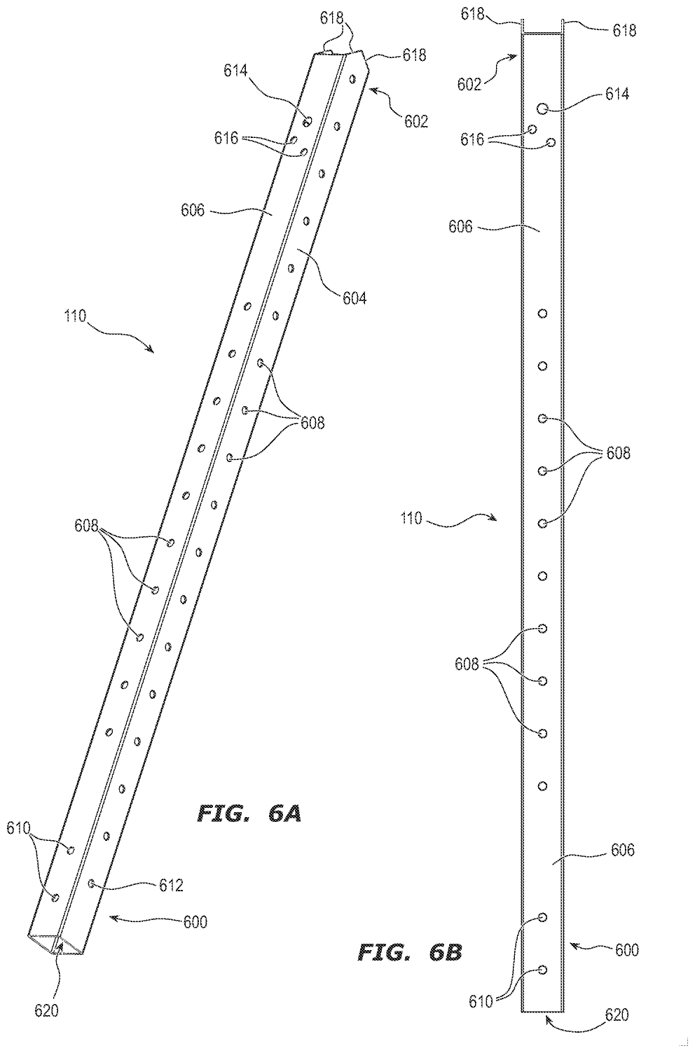

In one or more examples, the wheel chock baskets 106 are attached to a central support column 110 (e.g., a post, pillar, pole, upright, rod, stanchion, or support member). The wheel chock baskets 106 can be attached to the central support column 110 in various ways. For example, the wheel chock baskets 106 can be permanently affixed to the central support column 110. In other examples, the wheel chock baskets 106 are removably attached to the central support column 110. For instance, the wheel chock baskets 106 can be adjusted up or down to a desired height. In particular implementations, the wheel chock baskets 106 are height adjustable according to a plurality of attachment positions or apertures arranged along the central support column 110. Additional detail with respect to the central support column 110 is provided below in relation to FIGS. 6A-6B.

As mentioned, the wheel chock baskets 106 can be sized and shaped to receive the wheel chocks 108. In particular examples, the wheel chock baskets 106 are form fitted to receive a particular size and/or type of wheel chock. As used herein, the term “wheel chock” refers to a barrier or stop that can, upon placement against a vehicle wheel, prevent movement (e.g., rotational movement) of the vehicle wheel. A wheel chock can include one or more chocking faces (e.g., a wheel-engagement surface, a wedging wall, a stop surface, a contact surface, a tire-grip surface, etc.). A wheel chock can include various other features (e.g., a handle, bracket, traction-enhancing features, base surface, etc.). In these or other examples, a wheel chock can be used with many different types of vehicles, including an automobile, trailer, tractor, truck, crane, aircraft, and other wheeled vehicles. However, in some cases, a wheel chock of can also inhibit movement for non-wheeled vehicles (e.g., track vehicles like snowmobiles, track skid steers, etc.).

In at least one example, the wheel chock baskets 106 are interchangeable with one or more different wheel chock baskets. For instance, the wheel chock baskets 106 (as shown) are sized and shaped to receive a first set of wheel chocks (e.g., having a first set of dimensions compatible with a first range of aircraft wheel sizes). The wheel chock baskets 106 can be interchanged with a different pair of wheel chock baskets that are sized and shaped to receive a second set of wheel chocks (e.g., having a second set of dimensions compatible with a second range of aircraft wheel sizes). In these or other examples, the first set of wheel chock dimensions can differ from the second set of wheel chock dimensions (as can the first range of aircraft wheel sizes differ from the second range of aircraft wheel sizes). In this manner, the wheel chock cart 100 can implement the wheel chock baskets 106 in a modular fashion, thereby lending to more versatile and customizable use of the wheel chock cart 100.

Further shown, the wheel chock cart 100 can include a handle 112. The handle 112 can include various structure for a user to grasp, hold, drive, steer, steady, manipulate, and/or support the wheel chock cart 100 (as shown specifically in FIG. 1B). For example, the handle 112 can include a bar, grip, knob, lever, etc. In some examples (and as shown), the handle 112 can include a shaped bar that forms an opening, where each end of the shaped bar is attached to opposing sides of the central support column 110.

In these or other examples, the handle 112 can be attached to a top portion of the central support column 110. In other examples, the handle 112 is positioned between a top portion of the central support column 110 and the wheel chock baskets 106. In alternative examples, the wheel chock cart 100 can include multiple handles.

Additionally, the wheel chock cart 100 can include one or more whips 114. As used herein, the term “whip” refers to an elongate rod with a visual enhancement feature (e.g., a flag, light, and/or reflective surface). In particular examples, the whips 114 are semi-flexible or bendable and are designed to safely contact a vehicle (e.g., an aircraft wing) without causing damage to the vehicle or the whips 114. Thus, the whips 114 of the wheel chock cart 100 can be utilized to guide, direct, and/or park an aircraft. Further, the whips 114 can do so in a highly visual manner via one or more visual enhancement features, such as a flag, light, or reflective surface. In at least one example, a power supply stored on the bottom shelf 104 (and/or a solar array electrically coupled to the whips 114) can provide power to a light assembly of the whips 114 (see FIGS. 8-10).

The whips 114 can be sized in various configurations (e.g., according to aircraft size). For example, the whips 114 can include a length of about 1 foot to about 20 feet, about 3 feet to about 15 feet, about 5 feet to about 10 feet, or about 6 feet to about 8 feet. Further, in some examples, the whips 114 can be interchanged for different sized whips (e.g., for use with different sized aircraft).

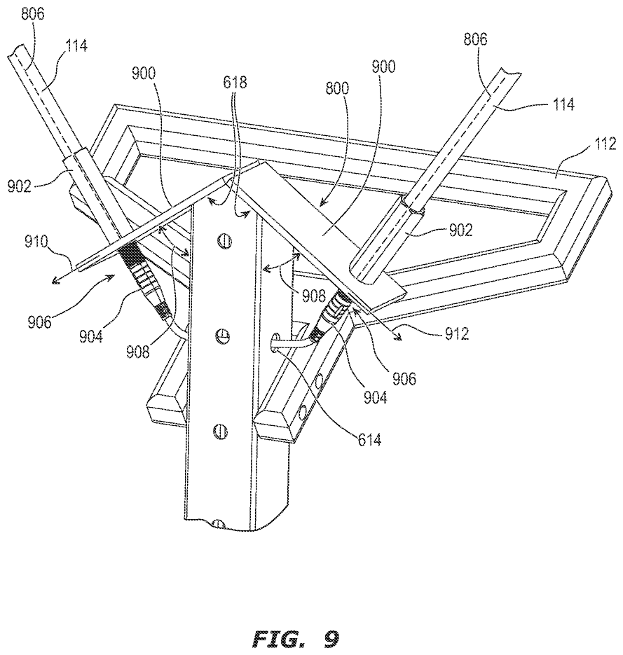

The whips 114 can be mounted to the central support column 110 in various ways, as will be described more below in relation to FIGS. 8-9. In these or other examples, the whips 114 can be attached or mounted to the central support column 110 in various locations (and at a variety of orientations or angles relative to the central support column 110). In some examples, the whips 114 are positioned at a top portion of the central support column 110 adjacent to the handle 112. In other examples, the whips 114 are positioned at a midsection or lower portion of the central support column 110.

It will be appreciated that the components of the wheel chock cart 100 can include one or more of a variety of different materials. In particular, the materials implemented by the wheel chock cart 100 can be resistant to the elements of outdoor environments, including rain, wind, snow, hail, dust, debris, extreme temperatures (e.g., below 32 degrees Fahrenheit and/or above 100 degrees Fahrenheit), etc. For instance, one or more portions of the wheel chock cart 100 can include material(s) that are resistant to corrosion. In particular examples, the wheel chock cart 100 implements a stainless steel material or a galvanized material. Additionally or alternatively, the wheel chock cart 100 can implement an elastomer material (e.g., rubber, silicone, etc.) or a similar overmolded material.

In at least one example, the wheel chock cart 100 can include a high-visibility material. As used herein, the term “high visibility material” refers to visibility-enhancing material or a visual aid. This high visibility material can include a myriad of different types of material (e.g., based on color luminance, photoluminescence, etc.). For example, the high visibility material can include a pigment (e.g., a colorant) having a color luminance greater than 50 percent. Such pigment can correspond to a hue with a natural luminance above 50 percent. Additionally or alternatively, the color luminance can exceed 50 percent by modifying saturation and/or lightness of the pigment.

In some examples, the high visibility material includes a chargeable light emissive material. As used herein, the term “chargeable light emissive material” refers to one or more elements capable of being charged (and recharged) to persistently emit light after exposure to light from a light source—with light energy or photons—that may be visible or invisible. In some embodiments, a chargeable light emissive material includes a mixture, alloy, or combination of elements with chargeable, light-emitting properties. A chargeable light emissive material can include a coating or layer (e.g., a dip coating or paint layer). A chargeable light emissive material can also include a discontinuous or weighted application of sprayed or printed material (e.g., particles, pigments, strips, layers, flecks, grains, drops, etc.). An example of a chargeable light emissive material includes luminescent materials (whether organic and/or synthetic)—including fluorescent materials, phosphorescent materials, and/or chemiluminescent materials. It will be appreciated that at least fluorescent materials can promptly exhibit photoluminescence very shortly after photoexcitation of the fluorescent materials. Additionally, as some particular examples, a chargeable light emissive material can include ultraviolet phosphors, blue light emitting diode phosphors, infrared emitting phosphors, Anti-Stokes phosphors (i.e., up-converters), glow-in-the-dark phosphors, x-ray phosphors, and storage phosphors. Other examples of a chargeable light emissive material include radioluminescent materials and cathodoluminescent materials.

It will be appreciated that a chargeable light emissive material can include a glow-in-the-dark material (e.g., a material that generates a luminous response or “glowing” output after being excited, such as via UV radiation from the sun). Then, when the wheel chock cart 100 is positioned in a darker environment (e.g., a cloudy environment, a foggy environment, a stormy environment, a nighttime environment), the glow-in-the-dark material can at least temporarily maintain its excited state and correspondingly generate a luminous response (e.g., without the need to reflect environmental light). For instance, a glow-in-the-dark or phosphorescent material is a material that has a fluorescence for which the average lifetime of the excited atoms is greater than 10⁻⁸ seconds.

In particular examples, the high visibility material can generate a luminous response (e.g., emit light at one or more wavelengths) perceivable to an unaided human eye when the chargeable light emissive material is exposed to an exciting agent at temperatures below incandescence. Such a luminous response can occur during oxidation or after exposure to light or other radiation. A luminous response can be modulated with electrical stimulation or other form of synthetic excitation in some examples (e.g., via a UV light assembly, a power supply connected to the high visibility material, a chemical agent, etc.). However, the high visibility material can (additionally or alternatively) include materials that can generate a luminous response independent of synthetic excitation. For example, the natural elements (e.g., sunshine) can be sufficient for the high visibility material to generate the luminous response when the sunshine is gone.

In these or other examples, an “unaided human eye” is a naked eye of an average human observer having regular vision and that is not augmented or supplemented by lenses, microscopes, cameras, or other scopes or equipment used to discern wavelengths beyond the natural human eye. In certain examples, the luminous response of the high visibility material may be visible to the unaided human eye in darker environments, particularly at night and/or during inclement weather. In some embodiments, the unaided human eye, as referred to herein, can detect light of wavelengths from about 342 nanometers to about 770 nanometers.

In some examples, the high visibility material is integrally formed as part of the wheel chock cart 100 (e.g., the wheel base 102, the bottom shelf 104, the wheel chock baskets 106, the central support column 110, the handle 112 and/or the whips 114)—whether embedded or otherwise irremovably positioned over one or more surfaces of the wheel chock cart 100 as a coating, molding, or spray-on application. In these or other examples, the high visibility material can lend to improved visibility of the wheel chock cart 100, particularly at night and/or during inclement weather.

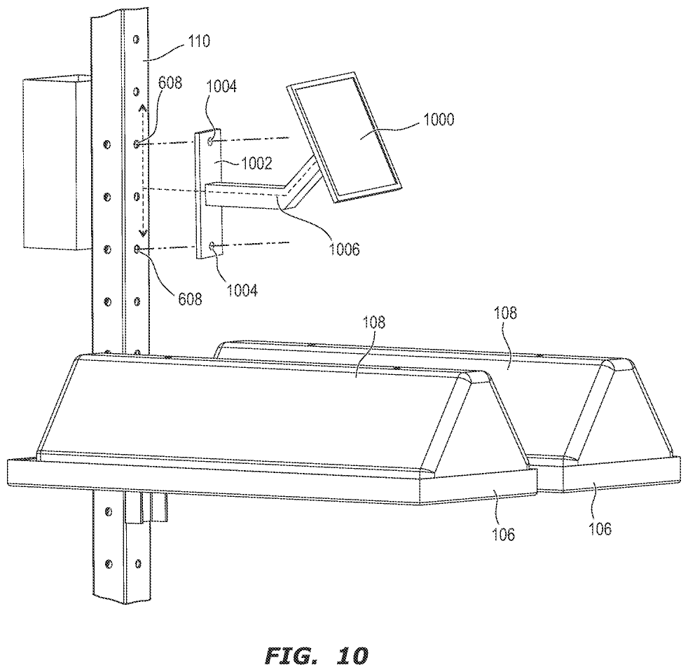

Modifications and additional/alternative use cases for various aspects of the wheel chock cart 100 are also herein contemplated. For example, the bottom shelf 104 can be implemented as an additional wheel chock basket. That is, the bottom shelf 104 can be used to carry/store a wheel chock in addition to (or alternatively to) a power supply or other object. In yet another example, the central support column 110 can support a wide variety of attachments in addition to (or alternatively to) the wand basket for marshalling wands, discussed in detail in FIG. 8. For instance, the central support column 110 can provide removable attachment or storage for personal protection equipment (e.g., gloves, hearing protection, eye protection, helmets, etc.), tools, flashlights, devices (e.g., computing devices, remotes, walkie-talkies), a first-aid kit, emergency kit, fire extinguisher, etc. In a further example, the wheel chock cart 100 can include signage (e.g., with symbols, indicators, alphanumeric values, etc.)—whether removably or permanently attached to the wheel chock cart 100—to aid the warning or direction of vehicle traffic. As a specific example, the wheel chock cart 100 can include signage designating a particular airport runway, terminal, or gate. In at least one example, the wheel chock cart 100 can include a solar array for charging a power supply and/or for providing power to a light assembly of the whips 114 (as discussed below in relation to FIG. 10).

Any of the features, components, and/or parts, including the arrangements and configurations thereof shown in FIGS. 1A-1B can be included, either alone or in any combination, in any of the other examples of devices, features, components, and parts shown in the other figures described herein. Likewise, any of the features, components, and/or parts, including the arrangements and configurations thereof shown and described with reference to the other FIGS. can be included, either alone or in any combination, in the example of the devices, features, components, and parts shown in FIGS. 1A-1B.

FIGS. 2-4 illustrate additional views of the wheel chock cart 100 discussed above. In particular, FIGS. 2-4 respectively illustrate perspective, top, and side views of the wheel chock cart 100 in accordance with one or more examples of the present disclosure. In these figures, the wheel chocks 108 are omitted for illustration purposes.

In particular, FIG. 3 shows certain aspects of the bottom shelf 104 and the wheel chock baskets 106. For example, the wheel chock baskets 106 can include a length 300 and a width 302. As mentioned above, the wheel chock baskets 106 can be sized and shaped to fit a variety of wheel chocks. The length 300 and the width 302 can thus be sized and shaped accordingly. For example, the length 300 can include a length of about six inches to about four feet, about one foot to about three feet, or about two feet. Similarly, the width 302 can include a width of about four inches to about three feet, about six inches to about two feet, about eight inches to about 1.5 feet, or about one foot.

The bottom shelf 104 can include the same or similar dimensions. For example, the bottom shelf 104 can include a length 304 and a width 306. As mentioned above, the bottom shelf 104 can be sized and shaped to fit a variety of objects, including one or more power supplies. The length 304 and the width 306 can thus be sized and shaped accordingly. For example, the length 304 can include a length of about four inches to about three feet, about six inches to about two feet, about eight inches to about 1.5 feet, or about one foot. Similarly, the width 306 can include a width of about six inches to about four feet, about one foot to about three feet, or about two feet.

The bottom shelf 104 and the wheel chock baskets 106 can be attached to the central support column 110 and oriented in a variety of configurations. For example, FIG. 3 shows the wheel chock baskets 106 can be positioned forward of the central support column 110 and above the bottom shelf 104. In particular, the wheel chock baskets 106 can extend longitudinally forward and away (i.e., approximately perpendicular) relative to a plane 308 (e.g., that is coplanar with a front face of the central support column 110). Conversely, the bottom shelf 104 can extend approximately parallel to the plane 308 and laterally between the wheel base 102, namely between the wheels and axle brackets. In other examples, however, at least one of the orientations of the bottom shelf 104 or the wheel chock baskets 106 can be rotated (e.g., about 90 degrees from the illustrated configuration). For instance, the bottom shelf 104 can be modified to extend longitudinally forward and away (i.e., approximately perpendicular) relative to the plane 308.

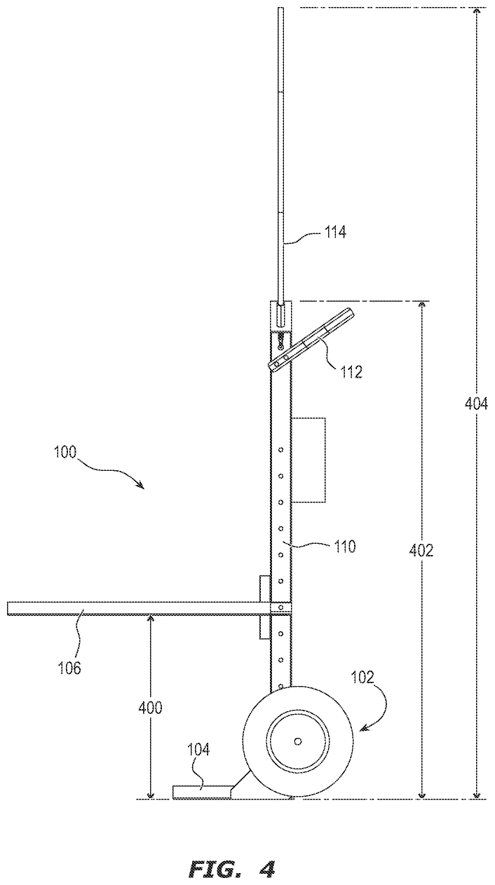

FIG. 4 depicts various example height relationships of components of the wheel chock cart 100, particularly when the wheel chock cart 100 is positioned upright in a resting state. In particular, the wheel chock baskets 106 can be positioned at a basket height 400, where the basket height 400 is defined as the amount of vertical rise from a ground surface (or a bottom surface of the bottom shelf 104) to the wheel chock baskets 106. The basket height 400 can be adjusted to a desired height (e.g., via attachment positions on the central support column 110, discussed in further detail below in relation to FIGS. 6A-6B). As examples, the basket height 400 can be adjusted to various positions incrementally spaced between about three inches and about six feet, between about one foot and about five feet, or between about 1.5 feet and about four feet. In certain examples, the basket height 400 is adjustable up or down to affect a center of gravity for the wheel chock cart 100. For instance, a lower basket height 400 can lower the center of gravity for the wheel chock cart 100 (thereby helping to stabilize the wheel chock cart 100 against wind forces or jet wash).

The wheel chock cart 100 can also include a cart height 402. The cart height 402 can be defined as the amount of vertical rise from a ground surface to the topmost portion of the central support column 110. Similarly, the wheel chock cart 100 can include a whip height 404. The whip height 404 can be defined as the amount of vertical rise from a ground surface to the topmost portion of the whips 114.

In these or other examples, the cart height 402 can range from about three feet to about seven feet, from about four feet to about six feet, or about five feet. In contrast, the whip height 404 can range from about six feet to about twenty feet, about eight feet to about fifteen feet, about nine feet to about thirteen feet, or about ten to twelve feet.

It will be appreciated that the whip height 404 is sized to provide a visual aid for all types of vehicles and operators (e.g., to define safe zones, prohibited zones, machinery zones, parking zones, or other designated areas). In particular examples, the whip height 404 is sized to provide a visual aid for aircraft pilots. Additionally, the whip height 404 can be sized to safely contact aircraft wings, which most conventional delineators are unable to do on account of being too short or prone to damaging the aircraft wings. For instance, the whip height 404 allows a pilot to maneuver an aircraft at a terminal or other outdoor environment and visualize where the aircraft is positioned in relation to the whips 114. That is, the wheel chock cart 100 includes the whips 114 having the whip height 404 (and a corresponding whip orientation) that can align aircraft wing tips at predetermined positions in an outdoor environment (e.g., at a specific gate, at a parking stall in a hangar, etc.).

Any of the features, components, and/or parts, including the arrangements and configurations thereof shown in FIGS. 2-4 can be included, either alone or in any combination, in any of the other examples of devices, features, components, and parts shown in the other figures described herein. Likewise, any of the features, components, and/or parts, including the arrangements and configurations thereof shown and described with reference to the other FIGS. can be included, either alone or in any combination, in the example of the devices, features, components, and parts shown in FIGS. 2-4.

FIG. 5 illustrates an assembled portion of the wheel chock cart 100, including the wheel base 102 and the bottom shelf 104 in greater detail, in accordance with one or more examples of the present disclosure. As shown, the wheel base 102 can include wheels 500, an axle 502 extending between the wheels 500, and axle braces 504. The axle braces 504 can include a variety of brackets, supports, wings, connections, joints, or braces attached to the axle 502. In certain examples, the axle braces 504 can rotate or swivel freely relative to the axle 502 (and vice-versa). This rotational independence between the axle 502 and the axle braces 504 can allow the axle braces 504 (and the bottom shelf 104 and the mounting sleeve 506) to pivot relative to the axle 502 as the wheel chock cart 100 moves between the upright position when at rest (shown in FIG. 1A) and an angled position relative to the upright position for moving the wheel chock cart 100 (as shown in FIG. 1B). The rotational independence between the axle 502 and the axle braces 504 also allows the axle 502 to freely rotate as the wheels 500 correspondingly rotate during movement of the wheel chock cart 100.

In other examples, the axle braces 504 are fixed (e.g., welded) to the axle 502, in which case the axle 502 can be a fixed (i.e., stationary) shaft. In this example, the axle braces 504 (together with the axle 502) can pivot relative to the wheels 500 (e.g., due to a bearing engagement between the axle 502 and the wheels 500).

In these or other examples, the bottom shelf 104 is integrally attached to the wheel base 102 via the axle braces 504. For example, the bottom shelf 104 is welded to the axle braces 504. Thus, the bottom shelf 104 can be permanently suspended from the axle braces 504 in some implementations.

Additionally shown, the wheel chock cart 100 can include a mounting sleeve 506 attached to the bottom shelf 104 (e.g., integrally attached at a rear side of the bottom shelf 104). The mounting sleeve 506 can include any mount, base, support, attachment, or joint for connecting to the central support column 110. That is, the central support column 110 can be removably attached to or otherwise disposed inside the mounting sleeve 506. In particular examples, the mounting sleeve 506 can define a mounting sleeve opening 508 that is sized and shaped to receive a bottom portion of the central support column 110. For instance, the mounting sleeve 506 can be designed as a female connection piece such that the bottom portion of the central support column 110 can be inserted into the mounting sleeve opening 508. In alternative implementations, however, the mounting sleeve 506 can be a male piece insertable into the bottom portion of the central support column 110. Fasteners (e.g., bolts, pins, etc.) can be inserted through apertures 510 defined by the mounting sleeve 506 to secure the bottom portion of the central support column 110 and the mounting sleeve 506 together. The apertures 510 can be arranged along any surface of the mounting sleeve 506. In this example, the apertures 510 are positioned at side surfaces of the mounting sleeve 506.

The mounting sleeve 506 can further include an aperture 512 defined by one or more surfaces of the mounting sleeve 506. The aperture 512 can be the same as or similar to the apertures 510, but utilized for a different purpose. For example, the aperture 512 can be sized and shaped as a cable opening through which a power and/or data cable (not shown) can extend. For instance, a power cable can extend from a power supply positioned on the bottom shelf 104, through the aperture 512 and into a corresponding opening in the central support column 110, up through an interior volume of the central support column 110, and connect with one or more components of the wheel chock cart 100 (e.g., a light assembly, a solar array, an actuator, etc.).

Any of the features, components, and/or parts, including the arrangements and configurations thereof shown in FIG. 5 can be included, either alone or in any combination, in any of the other examples of devices, features, components, and parts shown in the other figures described herein. Likewise, any of the features, components, and/or parts, including the arrangements and configurations thereof shown and described with reference to the other FIGS. can be included, either alone or in any combination, in the example of the devices, features, components, and parts shown in FIG. 5.

FIGS. 6A-6B respectively illustrate perspective and side views of the central support column 110 in accordance with one or more examples of the present disclosure. As mentioned, the central support column 110 can also be referred to as a post, pillar, pole, upright, rod, stanchion, or support member. The central support column 110 can therefore include a variety of configurations, shapes, sizes, and cross-sectional profiles. In particular examples, and as will be discussed more below, the central support column 110 can serve as the backbone or framework of the wheel chock cart 100 to which many components can be attached in a variety of ways and positions.

As shown, the central support column 110 can include a bottom portion 600 and a top portion 602. The bottom portion 600 is removably attachable to the mounting sleeve 506, as discussed above. For example, apertures 610 of the bottom portion 600 can align with apertures 510 of the mounting sleeve 506 such that fasteners can be inserted there through and join the central support column 110 and the mounting sleeve 506 together.

Similarly, aperture 612 defined by the bottom portion 600 can align with the aperture 512 of the mounting sleeve 506. In this way, a power cable can extend through both the apertures 512, 612 and into an interior volume 620 of the central support column 110 (e.g., for providing a power connection to one or more components of the wheel chock cart 100).

In these or other examples, a power cable can extend through the interior volume 620 (defined by interior walls of the central support column 110) and exit at one or more locations of the central support column 110. For instance, the power cable can exit through an aperture 614 defined by the top portion 602 of the central support column 110 (e.g., for a power connection with a light assembly of the whips 114, discussed more below in relation to FIGS. 8-9).

The top portion 602 can also include apertures 616 for securing the handle 112 to the central support column 110 via fasteners. Additionally, the top portion 602 can include a whip mount attachment surface 618 upon which a whip mount can be attached (whether removably or permanently attached). In some examples, the whip mount attachment surface 618 includes a flat surface. In other examples, the whip mount attachment surface 618 includes a pair of angled surfaces oriented to form a top point, peak, or vertex of the central support column 110. The angle of the whip mount attachment surface 618 can allow for a whip mount to be correspondingly angled (and therefore provide a V-shaped whip configuration). The V-shape configuration of whips can be visually distinctive or advantageous for visual signaling. Further, and as described below in relation to FIG. 9, the angle of the whip mount (due to the whip mount attachment surface 618) can impart water-shedding qualities that can improve water resistance of a power connection at or near the whip mount.

Additionally shown in FIGS. 6A-6B, the central support column 110 can include a plurality of attachment positions or apertures, namely apertures 608. The apertures 608 can be positioned along a front face 604 and/or a side face 606. In particular implementations, the apertures 608 are positioned along both of the front face 604 and the side face 606. The apertures 608 can be utilized for attaching one or more components to the central support column 110. For example, the apertures 608 can be utilized for attaching the wheel chock baskets 106 to the central support column 110, a wand bask (e.g., the wand basket 802 discussed below in relation to FIG. 8), and a solar array (e.g., the solar array 1000 discussed below in relation to FIG. 10). The apertures 608 can additionally or alternatively be utilized to attach accessory components or associated storage for items such as personal protection equipment (e.g., gloves, hearing protection, eye protection, helmets, etc.), tools, flashlights, devices (e.g., computing devices, remotes, walkie-talkies), a first-aid kit, emergency kit, fire extinguisher, etc.

It will be appreciated that the apertures 608 can include a variety of different spacing for a desired adjustment resolution between positions. For instance, the apertures 608 can have a spacing between apertures that ranges from about a quarter inch to about twelve inches, about a half inch to about eight inches, about one inch to about six inches, about three inches to about five inches, or about four inches. In certain examples, the apertures 608 can be labeled for convenient reference during positional adjustment of one or more components attachable to the central support column 110.

Any of the features, components, and/or parts, including the arrangements and configurations thereof shown in FIGS. 6A-6B can be included, either alone or in any combination, in any of the other examples of devices, features, components, and parts shown in the other figures described herein. Likewise, any of the features, components, and/or parts, including the arrangements and configurations thereof shown and described with reference to the other FIGS. can be included, either alone or in any combination, in the example of the devices, features, components, and parts shown in FIGS. 6A-6B.

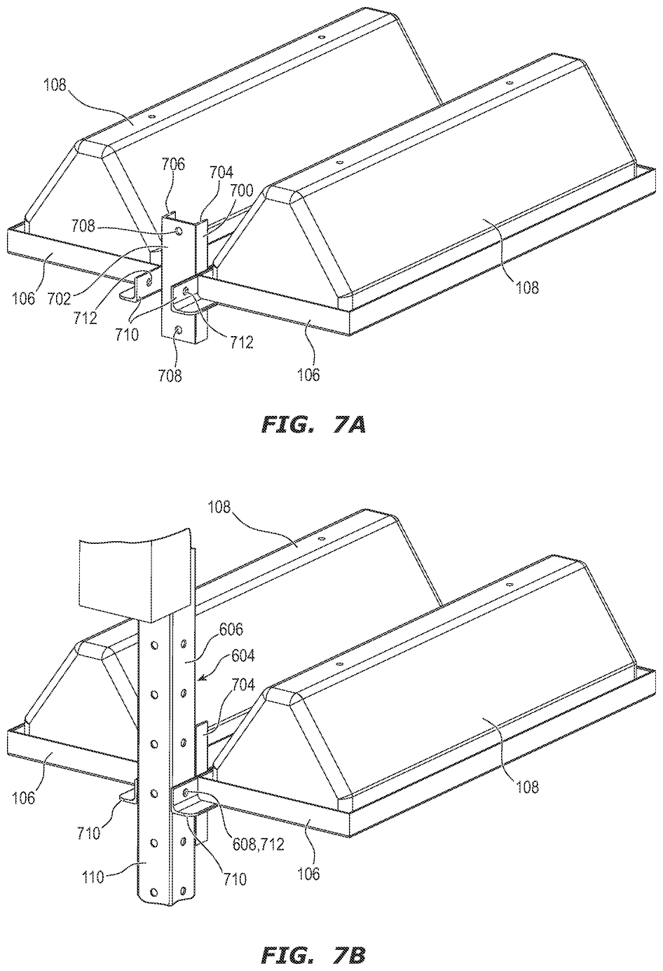

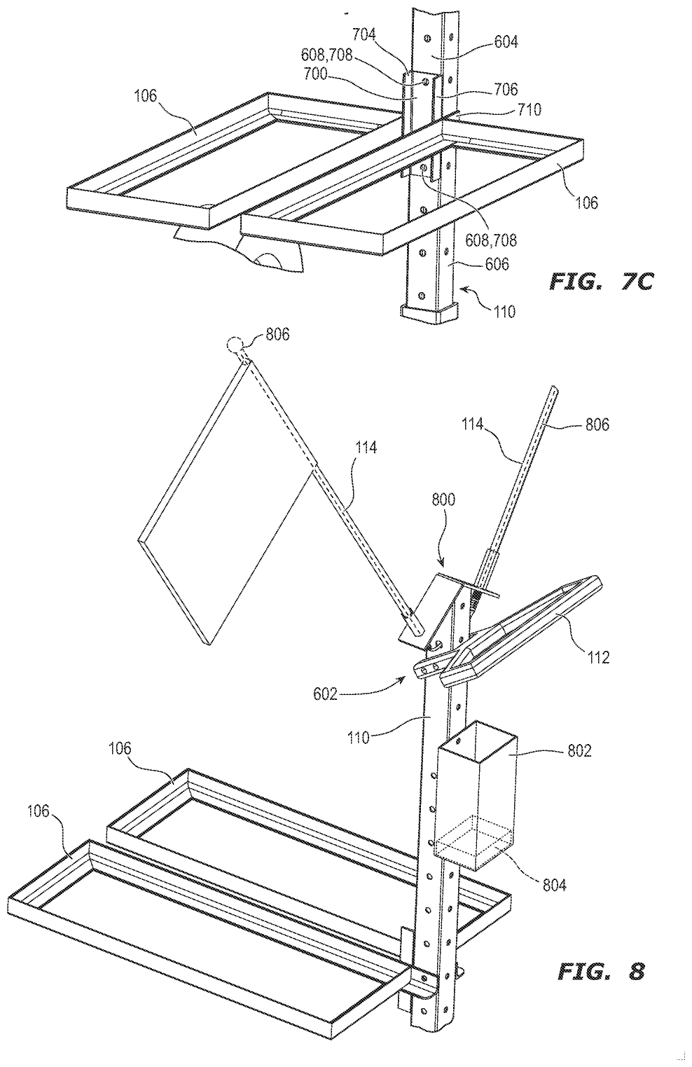

FIGS. 7A-7C illustrate a connection between the wheel chock baskets 106 and the central support column 110 in accordance with one or more examples of the present disclosure. For illustration purposes, FIG. 7A omits the central support column 110.

As shown, the wheel chock cart 100 can include a mounting bracket 700. In some examples, the mounting bracket 700 is attached (e.g., integrally attached or welded) to the wheel chock baskets 106. In some examples, the mounting bracket 700 is positioned perpendicular to the wheel chock baskets 106. In particular, the mounting bracket 700 can include flanges 704, 706 that are attached to the wheel chock baskets 106.

The mounting bracket 700 can further include an abutment surface 702 that can contact, abut, or be positioned adjacent to the front face 604 of the central support column 110. In some examples, the abutment surface 702 can increase the surface area of contact with the central support column 110 (and therefore improve load distribution, bending moment resistance, and/or attachment stability than could otherwise be achieved with the wheel chock baskets 106 alone).

Additionally, the mounting bracket 700 can define apertures 708 for aligning with the apertures 608 of the central support column 110 (e.g., along the front face 604 of the central support column 110). Fasteners can be positioned through the apertures 608, 708 when aligned to secure the mounting bracket 700 (and therefore the wheel chock baskets 106) to the central support column 110.

The wheel chock baskets 106 can also include connection portions 710 defining apertures 712. The connection portions 710 can include an extension (e.g., a bracket extension) of the wheel chock baskets 106. The connection portions 710 and associated apertures 712 can be used to secure the wheel chock baskets 106 to the side face 606 of the central support column 110 via fasteners. The connection portions 710, when connected to the side face 606, can help improve lateral bending or torsional resistance of the wheel chock baskets 106 in another plane. Accordingly, the wheel chock baskets 106 can include at least two planes of connection to the central support column 110 (e.g., at the front face 604 and the side face 606 of the central support column 110). In these or other examples, the two planes of connection to the central support column 110 can provide increased stability and torsional resistance in multiple planes for supporting the wheel chocks 108 on the wheel chock baskets 106.

Any of the features, components, and/or parts, including the arrangements and configurations thereof shown in FIGS. 7A-7C can be included, either alone or in any combination, in any of the other examples of devices, features, components, and parts shown in the other figures described herein. Likewise, any of the features, components, and/or parts, including the arrangements and configurations thereof shown and described with reference to the other FIGS. can be included, either alone or in any combination, in the example of the devices, features, components, and parts shown in FIGS. 7A-7C.

FIG. 8 illustrates various components attached to the wheel chock cart 100 in accordance with one or more examples of the present disclosure. As shown, the wheel chock cart 100 can include a whip mount 800. The whip mount 800 can include a bracket, shelf, support surface, or decking for attaching one or more whips 114. Additional detail with respect to the whip mount 800 is discussed below in relation to FIG. 9.

In some examples, the wheel chock cart 100 can additionally include a wand basket 802 adjustably positioned along the central support column 110 (e.g., via the apertures 608). The wand basket 802 can include a bin, box, container, holder, retention element, etc. for placing and storing marshalling wands. In some examples, the wand basket 802 can include a charging dock 804 (e.g., a conductive and/or inductive charging dock). In some examples, the charging dock 804 can be integrated inside the wand basket 802 (e.g., for charging one or more marshalling wands). In other examples, the charging dock 804 can be integrated with the wand basket 802 via external attachment to the wand basket 802 (e.g., for inductive charging through the bottom wall of the wand basket 802). It will be appreciated that the charging dock 804 can additionally (or alternatively) charge one or more other accessory devices (e.g., hearing protection devices, radios, computing devices, etc.).

In these or other examples, the charging dock 804 can be electrically coupled to a power supply of the wheel chock cart 100. For example, the charging dock 804 can be connected to a power supply positioned on the bottom shelf 104 via a power cable (as discussed above). In yet another example, the charging dock 804 can be connected to a solar array attached to the central support column 110 (discussed below in relation to FIG. 10).

Further shown in FIG. 8, the wheel chock cart 100 can, in some examples, include a light assembly 806 integrated with the whips 114. The light assembly 806 can include an illumination element, such as a light emitting diode, incandescent light, compact fluorescent light, halogen light, etc. In some implementations, the light assembly 806 can include a single bulb or light fixture housing that at least partially houses the illumination element. In other implementations, the light assembly 806 can include an arrangement of bulbs or light fixtures (e.g., a string of LEDs). The bulb or fixture housing of the light assembly 806 can also be positioned at a variety of locations (e.g., at a top pole of the whips 114, along the rod portion of the whips 114, or along a flag portion). The light assembly 806 can further include wiring that extends from the bulb or fixture housing to the power connection discussed below in relation to FIG. 9.

Any of the features, components, and/or parts, including the arrangements and configurations thereof shown in FIG. 8 can be included, either alone or in any combination, in any of the other examples of devices, features, components, and parts shown in the other figures described herein. Likewise, any of the features, components, and/or parts, including the arrangements and configurations thereof shown and described with reference to the other FIGS. can be included, either alone or in any combination, in the example of the devices, features, components, and parts shown in FIG. 8.

FIG. 9 illustrates a detailed view of the whip mount 800 in accordance with one or more examples of the present disclosure. As shown, the whip mount 800 can include brackets 900 positioned on the whip mount attachment surface 618. The brackets 900 can be positioned in a variety of positions and orientations (including a flat or horizontal orientation). In particular examples, however, the brackets 900 form an angle 908 relative to the central support column 110. The angle 908 can define an orientation of the whips 114 (e.g., to form a V-shape orientation). Additionally, the angle 908 for the brackets 900 can define water-shedding directions 910, 912. In particular implementations, water (e.g., rain, snow, etc.) can impact the brackets 900 and proceed along the surface of the brackets 900 in water-shedding directions 910, 912. In this manner, the whip mount 800 can impart water-resistance at least by shedding water away from a power connection 906. The power connection 906 can be defined as the electrical coupling between a whip connector 902 and a power cable 904.

The whip connectors 902 can be defined as base portion or connection piece between the rod portion of the whips 114 and the brackets 900. In particular, each whip connector 902 can include a respective attachment to the brackets 900 and another respective attachment (e.g., both mechanical and electrical) to one of the whips 114. With respect to the electrical attachment of the whip connectors 902, each light assembly 806 can include wiring that extends through the whips 114 and electrically couples to the whip connectors 902 to draw power through the power connection 906. Additionally or alternatively, the light assembly 806 can include wiring that extends continuously through the whips 114 and the whip connectors 902 to the power connection 906.

Any of the features, components, and/or parts, including the arrangements and configurations thereof shown in FIG. 9 can be included, either alone or in any combination, in any of the other examples of devices, features, components, and parts shown in the other figures described herein. Likewise, any of the features, components, and/or parts, including the arrangements and configurations thereof shown and described with reference to the other FIGS. can be included, either alone or in any combination, in the example of the devices, features, components, and parts shown in FIG. 9.

As mentioned previously, a variety of different components and/or accessory devices can be attached to the wheel chock cart 100. In accordance with one more such examples, FIG. 10 illustrates a solar array 1000 attachable to the wheel chock cart 100. The solar array 1000 can include a grouping of photovoltaic cells (e.g., forming a solar panel). The solar array 1000 can convert solar energy into electrical power transmittable to one or more components of the wheel chock cart 100 (e.g., a power supply, the light assembly 806, etc.) via a power cable 1006. In some examples, the solar array 1000 can be used to recharge a power supply and/or offload power discharge from the power supply (particularly during daytime hours).

As shown, solar array 1000 is attachable to the central support column 110 via apertures 608. The solar array 1000 is thus attachable to the central support column 110 in various orientations (e.g., in front-facing, side-facing, and/or rear-facing orientations). In particular examples, an attachment portion 1002 (e.g., an attachment bracket) of the solar array 1000 can include apertures 1004 for aligning with corresponding apertures 608 of the central support column 110. Fasteners can then be inserted through the apertures 1004, 608 upon alignment to secure the solar array 1000 to the central support column 110.

Any of the features, components, and/or parts, including the arrangements and configurations thereof shown in FIG. 10 can be included, either alone or in any combination, in any of the other examples of devices, features, components, and parts shown in the other figures described herein. Likewise, any of the features, components, and/or parts, including the arrangements and configurations thereof shown and described with reference to the other FIGS. can be included, either alone or in any combination, in the example of the devices, features, components, and parts shown in FIG. 10.

The foregoing description, for purposes of explanation, used specific nomenclature to provide a thorough understanding of the described examples. However, it will be apparent to one skilled in the art that the specific details are not required in order to practice the described examples. Thus, the foregoing descriptions of the specific examples described herein are presented for purposes of illustration and description. They are not intended to be exhaustive or to limit the examples to the precise forms disclosed.

It will be apparent to one of ordinary skill in the art that many modifications and variations are possible in view of the above teachings. Indeed, various inventions have been described herein with reference to certain specific aspects and examples. However, they will be recognized by those skilled in the art that many variations are possible without departing from the scope and spirit of the inventions disclosed herein. Specifically, those inventions set forth in the claims below are intended to cover all variations and modifications of the inventions disclosed without departing from the spirit of the inventions. The terms “including” or “includes” as used in the specification shall have the same meaning as the term “comprising.”

What is claimed is:

1. A wheeled cart, comprising:
a wheel base that includes a pair of wheels, axle braces positioned adjacent to each wheel of the pair of wheels, and an axle coupling the pair of wheels and extending through the axle braces;
a bottom shelf integrally attached to the wheel base via the axle braces, the bottom shelf sized and shaped to receive a power supply;
a mounting sleeve integrally attached to the bottom shelf;
a central support column removably disposed within and fastened to the mounting sleeve, the central support column having a plurality of attachment positions;
a whip mount positioned at a top portion of the central support column;
a handle attached to the central support column adjacent to the whip mount; and
a pair of wheel chock baskets positioned forward of the central support column and above the bottom shelf, the pair of wheel chock baskets being removably mounted to the central support column at a first attachment position of the plurality of attachment positions,
wherein the wheeled cart is self-standing in an upright position when at rest; and
wherein the wheeled cart is configured to be pushed or pulled when at an angled position relative to the upright position.

2. The wheeled cart of claim 1, further comprising a wand basket removably mounted to the central support column at a second attachment position of the plurality of attachment positions.

3. The wheeled cart of claim 2, further comprising a charging dock positioned adjacent to or integrally formed within the wand basket.

4. The wheeled cart of claim 1, further comprising a power cable routed through the central support column to provide power to one or more components, the power cable connectable to the power supply.

5. The wheeled cart of claim 4, wherein the power cable extends to and is electrically connectable with the whip mount.

6. The wheeled cart of claim 1, further comprising a solar array removably attached to the central support column at a second attachment position of the plurality of attachment positions, the solar array electrically connectable with at least one of the power supply or the whip mount.

7. The wheeled cart of claim 1, further comprising a mounting bracket positionable longitudinally along the central support column, the mounting bracket being removably mounted to the central support column at a second attachment position of the plurality of attachment positions,
wherein the mounting bracket is positioned between and integrally attached to the pair of wheel chock baskets.

8. The wheeled cart of claim 7, wherein the mounting bracket is positioned perpendicular to the pair of wheel chock baskets.

9. The wheeled cart of claim 1, further comprising a whip attached to the whip mount.

10. The wheeled cart of claim 9, wherein the whip includes at least one of a flag, light, or reflective surface.

11. A cart for moving aviation wheel chocks in an outdoor environment, the cart comprising:
a bottom shelf sized and shaped to receive a power supply;
a mounting sleeve attached to the bottom shelf;
a post removably disposed within and fastened to the mounting sleeve, the post defining a plurality of apertures;
a whip mount attached to the post;
a whip attachable to the whip mount;
a handle attached to a top portion of the post; and
a pair of wheel chock baskets removably mounted to the post at an aperture of the plurality of apertures.

12. The cart of claim 11, wherein the cart is configured to be visible in the outdoor environment during nighttime or inclement weather.

13. The cart of claim 11, wherein the cart is configured to self-stand and remain in place when exposed to jet wash or windy conditions.

14. The cart of claim 11, wherein when the whip is attached to the whip mount, the whip is sized and oriented at a height to align aircraft wing tips at predetermined positions in the outdoor environment.

15. The cart of claim 11, wherein the pair of wheel chock baskets is height adjustable from the aperture of the plurality of apertures to a different aperture of the plurality of apertures.

16. The cart of claim 11, wherein the whip includes a light assembly powered by the power supply.

17. The cart of claim 11, wherein:
the whip mount comprises a power connection to the power supply; and
the whip mount is angularly oriented relative to the post such that, upon exposure to water, the water is shed away from the power connection.

18. A wheel chock cart, comprising:
a bottom shelf sized and shaped to receive a power supply;
a mounting sleeve attached to the bottom shelf;
a post removably disposed within and fastened to the mounting sleeve, the post defining a plurality of apertures;
a whip mount attached to the post;
a whip attachable to the whip mount and comprising a light assembly;
a power cable extending through the post and connectable with the light assembly;
a handle attached to a top portion of the post;
a pair of wheel chock baskets removably mounted to the post at a first aperture of the plurality of apertures; and
a wand basket removably mounted to the post at a second aperture of the plurality of apertures.

19. The wheel chock cart of claim 18, wherein the pair of wheel chock baskets is interchangeable with a different pair of wheel chock baskets.

20. The wheel chock cart of claim 19, wherein:
each wheel chock basket of the pair of wheel chock baskets is sized and shaped to receive a first wheel chock; and
each wheel chock basket of the different pair of wheel chock baskets is sized and shaped to receive a second wheel chock different from the first wheel chock.
